(19) United States
(12) Patent Application Publication
(10) Pub. No.: US 2017/0298841 A1
(43) Pub. Date: Oct. 19, 2017

(54) DIESEL ENGINE AND METHOD FOR OPERATING A DIESEL ENGINE

(71) Applicant: MTU FRIEDRICHSHAFEN GMBH, Friedrichshafen (DE)

(72) Inventors: Christoph LUCKAS, Kressbronn (DE); Wolfgang FIMML, Hörbranz (AT); Johannes SCHALK, Friedrichshafen (DE); Jonathan LIPP, Friedrichshafen (DE)

(73) Assignee: MTU FRIEDRICHSHAFEN GMBH, Friedrichshafen (DE)

(21) Appl. No.: 15/516,166

(22) PCT Filed: Nov. 30, 2015
(86) PCT No.: PCT/EP2015/002404

§ 371 Date: Mar. 31, 2017

(30) Foreign Application Priority Data
Jan. 13, 2015 (DE) 102015000432.8

(51) Int. Cl. F02D 13/02

(52) U.S. Cl. CPC F02D 13/0234; F02D 2013/0292

(57) ABSTRACT

A diesel engine, in particular a high-power diesel engine, having a variable valve train including an adjusting unit at least for adjusting a cam angle of at least one inlet valve, and a control or regulating unit having at least one operating mode which is for cold starting. The control and/or regulating unit is designed in an operational mode, to adjust the cam angle of the at least one inlet valve to ‘late’ by controlling the adjusting unit.

The invention relates to a diesel engine, in particular a high-power diesel engine, and to a method for operating an internal combustion engine of said type.

Diesel engines tend to exhibit increased HC emissions, which are also visible as white smoke, in the lower load range, for example at idle, in the presence of cold ambient conditions. To improve exhaust-gas values, in particular in order to reduce the white smoke, it is already known for a compression ratio to be raised, whereby a compression end temperature is increased. Owing to the increased compression ratio, it is however possible to generate only a relatively low level of power. It is likewise known for a cold-start capability to be improved by means of additional components, for example a charge-air heater.

The invention is based in particular on the object of further optimizing a diesel engine and an operating mode of the diesel engine. Said object is achieved by means of an embodiment according to the invention corresponding to claim 1 and by means of a method according to the invention corresponding to claim 6. Refinements of the invention will emerge from the dependent claims.

A diesel engine is proposed, in particular a high-power diesel engine, having a variable valve drive which has an adjustment unit at least for adjustment of a closing angle of at least one inlet valve, and having an open-loop and/or closed-loop control unit for activating the adjustment unit, which open-loop and/or closed-loop control unit is provided so as, at least in an operating mode which is provided for a cold start, to adjust the closing angle of the at least one inlet valve in a retarding direction. In particular in the case of a diesel engine which is operated in accordance with the Miller cycle, it is firstly possible by way of the later closing of the inlet valves in relation to the Miller cycle to increase a volumetric efficiency and thus a cylinder charge. Secondly, charge-air cooling as a result of expansion during an intake stroke can be reduced. Both lead to a higher compression end temperature. Adjustment of the closing angle, for example by virtue of a camshaft phase position being adjusted in a retarding direction, and the associated higher ignition temperature can result in improved ignition characteristics during the cold start. In particular, a fraction of unburned hydrocarbons in an exhaust gas can be reduced, whereby running behavior directly after the cold start can be improved. Furthermore, the diesel engine can be brought to an operating temperature more quickly, without the need for additional components, such as in particular a charge-air heater, to be provided. By means of an embodiment with a variable valve drive and an open-loop and/or closed-loop control unit, it is thus possible to provide a diesel engine with improved cold-start characteristics. Here, a “closing angle” is to be understood in particular to mean an angle, referring to a camshaft angle or a crankshaft angle, at which the corresponding inlet valve closes. The closing angle may for example be adjusted through adjustment of a camshaft phase position. It is however basically possible for different variable valve drives to be used. A “camshaft phase position” is to be understood in particular to mean a phase position of a camshaft angle relative to a crankshaft angle. A “camshaft angle” is to be understood in particular to mean a rotational angle position of a camshaft relative to a defined zero point, for example at the start of a combustion cycle. A “crankshaft angle” is to be understood in particular to mean a rotational angle position of a crankshaft relative to the same defined zero point as the camshaft angle. An “adjustment in a retarding direction” is to be understood in particular to mean that the closing angle of the at least one inlet valve is shifted in the direction of a later closing angle. A “cold start” is to be understood in particular to mean a start of the diesel engine in the presence of an engine temperature below a normal operating temperature. An “engine temperature” is to be understood here, and below, in particular to mean a temperature value relating to an operating medium, such as for example a cooling water temperature or an engine oil temperature. A “normal operating temperature” is to be understood in particular to mean an engine temperature which is adjusted to by closed-loop control during continuous operation. An “open-loop and/or closed-loop control unit” is to be understood in particular to mean a unit with at least one set of control electronics. “Control electronics” are to be understood in particular to mean a unit with a processor unit and with a memory unit and with an operating program stored in the memory unit. “Provided” is to be understood in particular to mean specially programmed, configured and/or equipped.

Furthermore, the open-loop and/or closed-loop control unit may be provided so as to adjust the closing angle of the at least one inlet valve to a maximum extent in the retarding direction. In this way, it is possible to realize a particularly high level of cylinder charging. If the closing angle is adjusted to a maximum extent in a retarding direction, that is to say if the camshaft phase position is adjusted to a maximum extent as far as a limitation, such as for example a mechanical stop or an electronic limitation, an activation of the adjustment unit can be simplified, because the adjustment unit merely has to be adjusted against the limitation.

The adjustment unit may have a camshaft adjuster with a maximum adjustment, by means of which the camshaft adjuster is provided so as to shift the closing angle of the at least one inlet valve into an angle range in which a piston assigned to the inlet valve passes through a bottom dead center. By virtue of the fact that the camshaft adjuster can shift the closing angle into the angle range which is assigned to the bottom dead center, particularly advantageous cylinder charging can be realized, whereby particularly high combustion temperatures can be realized. An “angle range” in which a piston assigned to the inlet valve passes through a bottom dead center is in this context to be understood in particular to mean an angle range, referring to a camshaft angle or a crankshaft angle, in which the piston passes through the bottom dead center. An “angle range” is in this context to be understood in particular to mean that the closing angle deviates by at most 20 degrees crankshaft angle, in particular by at most 10 degrees crankshaft angle, from a crankshaft angle at which the piston assigned to the inlet valve passes through the bottom dead center.

The diesel engine may basically have cylinders with any desired swept volume and/or any desired cylinder power. The diesel engine preferably has a cylinder power of at least 50 kW and/or cylinders which each have a swept volume of at least 1.6 l. In particular in the case of such high-power diesel engines, it is possible, for example as a result of the adjustment of the camshaft phase position, to easily achieve improved cold-start behavior. A “total cylinder volume” is to be understood to mean a volume of the combustion chamber before a compression, that is to say at a bottom dead center of the corresponding piston. By contrast, a “compression volume” is to be understood in particular to mean a volume of the combustion chamber after a compression, that is to say at a top dead center of the corresponding piston. A “swept volume” is to be understood in particular to mean a volume which is defined by a piston cross-sectional area and the piston stroke. The swept volume thus corresponds to the total cylinder volume minus the compression volume.

Further advantages will emerge from the following FIGURE description. The single FIGURE illustrates an exemplary embodiment of the invention. The FIGURE, the FIGURE description and the claims encompass numerous further features.

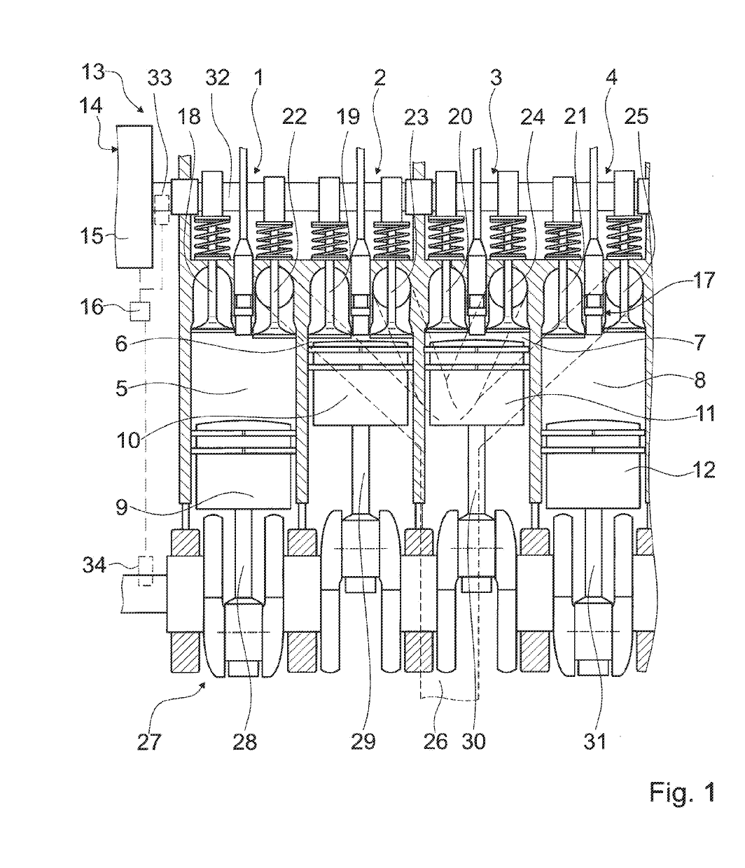

FIG. 1 schematically shows a diesel engine which is basically suitable for use in heavy agricultural vehicles, in rail vehicles or in watercraft. The diesel engine comprises multiple cylinders 1, 2, 3, 4 which have in each case one combustion chamber 5, 6, 7, 8, for the combustion of an air-fuel mixture, and a piston 9, 10, 11, 12 guided in the combustion chamber 5, 6, 7, 8. The diesel engine comprises, for each cylinder 1, 2, 3, 4, at least one injector 17 which is provided for introducing fuel into the combustion chamber 5, 6, 7, 8 of the respective cylinder 1, 2, 3, 4. For the sake of simplicity, in FIG. 1, only one of the injectors 17 is provided with a reference designation. The cylinders 1, 2, 3, 4 comprise in each case one or more inlet valves 18, 19, 20, 21 and one or more outlet valves 22, 23, 24, 25. The inlet valves 18, 19, 20, 21 are provided for supplying combustion air to the combustion chamber 5, 6, 7, 8 of the corresponding cylinder 1, 2, 3, 4. The fuel is injected into the combustion air in the respective combustion chamber 5, 6, 7, 8. As a result of compression, the air-fuel mixture in the respective combustion chamber 5, 6, 7, 8 is ignited. Via the outlet valves 22, 23, 24, 25, an exhaust gas which is generated as a result of combustion of the air-fuel mixture is supplied to an exhaust-gas system 26. For the actuation of the inlet valves 18, 19, 20, 21 and of the outlet valves 22, 23, 24, 25, the diesel engine comprises a valve drive 13 with at least one camshaft 32 which, in the exemplary embodiment illustrated, for the sake of simplicity of the drawing, is illustrated as a combined inlet and outlet camshaft. It is basically also conceivable for separate camshafts to be provided for the inlet valves 18, 19, 20, 21 and the outlet valves 22, 23, 24, 25.

The diesel engine is designed as a fast-running diesel engine. In the exemplary embodiment illustrated, the diesel engine has an idle rotational speed of approximately 600 rpm. A maximum rotational speed is approximately 2200 rpm in the exemplary embodiment illustrated. Each combustion chamber 5, 6, 7, 8 of the diesel engine has a cylinder volume of 4.77 l. A cylinder power of the diesel engine is approximately 150 kW.

Depending on the type of construction, the diesel engine may have between 8 and 20 cylinders 1, 2, 3, 4. The diesel engine is thus provided for a power of between 1200 kW and 3000 kW. The diesel engine may however basically also have other engine data.

Furthermore, the diesel engine comprises a crankshaft 27. The cylinders 1, 2, 3, 4 comprise in each case one connecting rod 28, 29, 30, 31 which connects the piston 9, 10, 11, 12 of the corresponding cylinder 1, 2, 3, 4 to the crankshaft 27. The cylinders 1, 2, 3, 4 have in each case a piston stroke which is dependent in particular on a design of the crankshaft 27. The piston stroke is equal for all of the cylinders 1, 2, 3, 4. The cylinders 1, 2, 3, 4 have in each case a swept volume, which is defined by a piston cross-sectional area and the piston stroke, and a compression volume, which corresponds to a remaining residual volume of the combustion chamber 5, 6, 7, 8 at a top dead center of the corresponding piston 9, 10, 11, 12. Each cylinder 1, 2, 3, 4 has a total cylinder volume which corresponds to a sum of swept volume and compression volume. The total cylinder volume of the combustion chambers 5, 6, 7, 8 of the cylinders 1, 2, 3, 4 of the diesel engine is in each case 4.77 l in the exemplary embodiment illustrated.

The camshaft 32 comprises a multiplicity of cams for the actuation of the inlet valves 18, 19, 20, 21 and of the outlet valves 22, 23, 24, 25. Each of the cams is assigned to exactly one of the inlet valves 18, 19, 20, 21 or one of the outlet valves 22, 23, 24, 25. Each of the cams has a cam curve which defines a valve opening time and a valve lift for the inlet valve 18, 19, 20, 21 or outlet valve 22, 23, 24, 25 assigned to the cam. A relative rotational angle interval between the cams provided for the inlet valves 18, 19, 20, 21 and the cams provided for the outlet valves 22, 23, 24, 25 defines a valve spread.

The valve drive 13 has a camshaft phase position which describes a relative angular position of the camshaft 32 with respect to the crankshaft 27. The crankshaft 27 has a crankshaft angle which, in one complete cycle of the diesel engine, runs through an angle range from 0 degrees to 720 degrees. The camshaft 32 has a camshaft angle which, in the complete cycle of the diesel engine, runs through an angle range from 0 degrees to 360 degrees. Since the valve drive 13 has a transmission ratio of 2:1, that is to say two revolutions of the crankshaft 27 correspond to one revolution of the camshaft 32, a camshaft angle of 360 degrees corresponds to a crankshaft angle of 720 degrees. Here, the diesel engine comprises a camshaft sensor 33, which is provided for determining the present camshaft angle, and a crankshaft sensor 34, which is provided for determining the present crankshaft angle. The valve drive 13 is provided for operation in accordance with the Miller cycle, in which the inlet valves 18, 19, 20, 21 are closed already during an intake stroke.

For the adjustment of the valve opening times, of the valve lift and/or of the valve spread, the valve drive 13 is configured to be variable. The valve drive 13 comprises an adjustment unit 14 which is provided in particular for varying a closing angle of the inlet valves 18, 19, 20, 21 by adjustment of the camshaft phase position. The adjustment unit 14 is provided for rotating the camshaft 32 relative to the crankshaft 27. For the adjustment of the camshaft phase position, the adjustment unit 14 comprises a camshaft adjuster 15 which has an adjustment range of at least 35 degrees with regard to the crankshaft angle. In a basic position, that is to say the camshaft phase position is 0 degrees, the camshaft 32, at a crankshaft angle of 0 degrees, has a rotational angle position of 0 degrees in relation to the crankshaft angle. In the event of a maximum adjustment of the camshaft phase position, that is to say the camshaft phase position is 35 degrees, the camshaft 32 has a rotational angle position of 35 degrees in relation to the crankshaft angle. Here, the valve drive may be provided in various mechanical, electrical, pneumatic and/or hydraulic embodiments which form a variable valve drive. In the exemplary embodiment illustrated, the adjustment unit 14, which has only the camshaft adjuster 15, is provided merely for adjusting the camshaft phase position. Alternatively or in addition, the adjustment unit 14 may have a multiplicity of actuators which are arranged in each case between the camshaft 32 and one of the inlet valves 18, 19, 20, 21, wherein the actuators are provided for varying a coupling between the camshaft 32 and the corresponding inlet valve 18, 19, 20, 21. In such an embodiment, the adjustment unit is provided in particular for additionally varying valve opening times and/or valve lifts at least of the inlet valves 18, 19, 20, 21 and/or valve spreads between the inlet valves 18, 19, 20, 21 and the outlet valves 22, 23, 24, 25.

The camshaft adjuster 15 may be provided in various embodiments. For example, the camshaft adjuster 15 may be in the form of a hydraulic vane-type adjuster. Alternatively, an embodiment as an electromechanical camshaft adjuster 15 is also conceivable. It is basically also possible for the camshaft adjuster 15 to be replaced by a variable valve drive which permits switching between different cam curves, which differ in particular with regard to their valve opening times. In the exemplary embodiment illustrated, owing to the camshaft 32 being formed as an inlet and outlet camshaft, the valve opening times of the inlet valves 18, 19, 20, 21 and of the outlet valves 22, 23, 24, 25 are adjustable only jointly.

The camshaft adjuster 15 has an advancing stop and a retarding stop, which define the adjustment range of the camshaft adjuster 15. In the basic position, in which the camshaft phase position is 0 degrees, the camshaft adjuster 15 has been adjusted against the advancing stop. At a camshaft phase position of 0 degrees, the inlet valves 18, 19, 20, 21 preferably open before the corresponding piston 9, 10, 11, 12 has passed through its top dead center, and close before the corresponding piston 9, 10, 11, 12 reaches its bottom dead center. At a camshaft phase position of 0 degrees, the inlet valves 18, 19, 20, 21 have an opening angle which preferably corresponds to a crankshaft angle of between 240 degrees and 180 degrees before bottom dead center, and a closing angle which preferably corresponds to a crankshaft angle of between 60 degrees and 10 degrees before bottom dead center.

The camshaft adjuster 15 has a position of maximum adjustment defined by the retarding stop, by means of which position of maximum adjustment the camshaft adjuster 15 is provided so as to shift the closing angle of the inlet valves 18, 19, 20, 21 into an angle range in which the piston 9, 10, 11, 12 assigned to the respective inlet valve 18, 19, 20, 21 passes through the bottom dead center. If the camshaft adjuster 15 has been adjusted against the retarding stop, the closing angle of the inlet valves 18, 19, 20, 21 has been adjusted in the retarding direction by 35 degrees crankshaft angle in relation to the basic position. At maximum adjustment, the inlet valves 18, 19, 20, 21 thus have a closing angle which corresponds to a crankshaft angle of between 25 degrees before bottom dead center and 25 degrees after bottom dead center. The closing angles of the inlet valves 18, 19, 20, 21 thus lie in the angle range in which the bottom dead center of the piston 9, 10, 11, 12 to which the corresponding inlet valve 18, 19, 20, 21 is assigned lies.

For the activation of the adjustment unit, the diesel engine comprises an open-loop and closed-loop control unit 16. The open-loop and closed-loop control unit 16 has an operating mode which is provided for a cold start. The open-loop and closed-loop control unit 16 is provided so as, in the operating mode, by activation of the adjustment unit 14, to adjust the camshaft phase position and thus the closing angles of the inlet valves 18, 19, 20, 21 in a retarding direction.

During a cold start, an engine temperature upon starting of the diesel engine lies below a normal operating temperature. For the activation of the operating mode, a parameter for a threshold temperature which lies below the normal operating temperature is stored in the open-loop and closed-loop control unit 16. The threshold temperature below which the open-loop and closed-loop control unit 16 activates the operating mode corresponds, in the exemplary embodiment illustrated, to an engine temperature of approximately 50 degrees. The normal operating temperature to which the diesel engine is preferably adjusted by closed-loop control during continuous operation is approximately 90 degrees. The engine temperature is in this case defined by way of a coolant temperature.

The open-loop and closed-loop control unit 16 is provided so as, in the operating mode, to adjust the camshaft phase position to a maximum extent in a retarding direction. To implement the position of maximum adjustment of the camshaft adjuster 15 as quickly as possible during the cold start, the open-loop and closed-loop control unit 16 activates the camshaft adjuster 15 with maximum adjustment speed in the retarding direction, for example by opening an associated magnetic closed-loop control valve to a maximum extent. Ideally, the camshaft adjuster 15 thereby attains the position of maximum adjustment before a first ignition of the diesel engine.

1-6. (canceled)

7. A diesel engine, in particular high-power diesel engine, comprising: at least one inlet valve; a variable valve drive which has an adjustment unit at least for adjustment of a closing angle of the at least one inlet valve; and an open-loop and/or closed-loop control unit which has at least one operating mode provided for a cold start of the engine, wherein the open-loop and/or closed-loop control unit is provided so as, in the operating mode, adjusts the closing angle of the at least one inlet valve in a retarding direction by activation of the adjustment unit.

8. The diesel engine according to claim 7, wherein the open-loop and/or closed-loop control unit is operatively configured to adjust the closing angle of the at least one inlet valve to a maximum extent in the retarding direction.

9. The diesel engine according to claim 7, further comprising a camshaft and a piston assigned to the inlet valve, wherein the adjustment unit has a camshaft adjuster with a position of maximum adjustment in which the closing angle of the at least one inlet valve is shifted at least into an angle range in which the piston assigned to the inlet valve passes through a bottom dead center.

10. The diesel engine according to claim 7, comprising a cylinder power of at least 50 kW.

11. The diesel engine according to claim 7, comprising at least one cylinder that has a swept volume of at least 1.6 l.

12. A method for operating a diesel engine having a variable valve drive with an adjustment unit at least for adjustment of a closing angle of at least one inlet valve, the method comprising adjusting, in an operating mode provided for a cold start, the closing angle of the at least one inlet valve in a retarding direction by activating the adjustment unit with an open-loop and/or closed-loop control unit.
